(19) United States
(12) Patent Application Publication
(10) Pub. No.: US 2012/0205559 A1
(43) Pub. Date: Aug. 16, 2012

(54) TARGET SUPPLY DEVICE AND EXTREME ULTRAVIOLET LIGHT GENERATION APPARATUS

(76) Inventors: Takayuki Yabu, Hiratsuka-shi (JP); Kouji Kakizaki, Hiratsuka-shi (JP); Osamu Wakabayashi, Hiratsuka-shi (JP)

(21) Appl. No.: 13/351,884

(22) Filed: Jan. 17, 2012

(30) Foreign Application Priority Data
Feb. 10, 2011 (JP) 2011-027576

(51) Int. Cl. G21K 5/00; B65D 35/38

(52) U.S. Cl. 250/504 R; 222/566

(57) ABSTRACT

A target supply device is configured for supplying a target material for generating an extreme ultraviolet (EUV) light. The target supply device comprises a target storage unit for storing at least the target material, and a target discharge unit comprising a surface having an opening from which a through-hole extends to communicate with the target storage unit. The target material is discharged through the opening for generating the EUV light. The surface at least around the opening is formed of a material so that the target material has a contact angle greater than 90 degrees with the surface.

### CROSS-REFERENCE TO RELATED APPLICATION

The present application claims priority from Japanese Patent Application No. 2011-027576 filed Feb. 10, 2011.

### BACKGROUND

1. Technical Field

This disclosure relates to a target supply device and an extreme ultraviolet (EUV) light generation apparatus.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication at 32 nm or less, for example, an exposure apparatus is expected to be developed, in which an apparatus for generating extreme ultraviolet (EUV) light at a wavelength of approximately 13 nm is combined with a reduced projection reflective optical system.

Three kinds of apparatuses for generating EUV light have been known in general, which include an LPP (Laser Produced Plasma) type apparatus in which plasma generated by irradiating a target material with a laser beam is used, a DPP (Discharge Produced Plasma) type apparatus in which plasma generated by electric discharge is used, and an SR (Synchrotron Radiation) type apparatus in which orbital radiation is used.

### SUMMARY

A target supply device is configured for supplying a target material for generating an extreme ultraviolet (EUV) light. The target supply device comprises a target storage unit for storing at least the target material, and a target discharge unit comprising a surface having an opening from which a through-hole extends to communicate with the target storage unit. The target material is discharged through the opening for generating the EUV light. The surface at least around the opening is formed of a material so that the target material has a contact angle greater than 90 degrees with the surface.

### BRIEF DESCRIPTION OF THE DRAWINGS

Hereinafter, selected embodiments of this disclosure will be described with reference to the accompanying drawings.

FIG. 1 schematically illustrates the configuration of an exemplary LPP type EUV light generation system.

FIG. 2A is a partial sectional view illustrating the configuration of an electrostatic-pull-out type droplet generation system which includes a target supply device according to any of first through fourth embodiments.

FIG. 2B is an enlarged sectional view showing part of FIG. 2A.

FIG. 3 is a sectional view illustrating part of a nozzle of the target supply device according to the first embodiment.

FIG. 4 is a sectional view illustrating part of a nozzle of the target supply device according to the second embodiment.

FIG. 5 is a sectional view illustrating part of a nozzle of the target supply device according to the third embodiment.

FIG. 6 is a sectional view illustrating part of a nozzle of the target supply device according to the fourth embodiment.

FIG. 7 is a table showing contact angles of molten tin on various materials.

FIG. 8A is a partial sectional view illustrating the configuration of a droplet generation system which includes a target supply device according to a fifth embodiment.

FIG. 8B is a partial sectional view illustrating the configuration of a droplet generation system which includes a target supply device according to the fifth embodiment.

FIG. 9 is a sectional view illustrating part of a target supply device according to a sixth embodiment.

FIG. 10 is a sectional view illustrating part of a target supply device according to a seventh embodiment.

FIG. 11 is a sectional view illustrating part of a target supply device according to an eighth embodiment.

### DESCRIPTION OF PREFERRED EMBODIMENTS

Hereinafter, selected embodiments of this disclosure will be described in detail with reference to the accompanying drawings. The embodiments to be described below are merely illustrative in nature and do not limit the scope of this disclosure. Further, the configuration and operation described in each embodiment are not all essential in implementing this disclosure. Note that like elements are referenced by like reference numerals or characters and duplicate descriptions thereof will be omitted herein.

### Contents

### 1. Summary

### 2. Terms

### 3. Overview of EUV Light Generation System

3.1 Configuration

3.2 Operation

### 4. Electrostatic-Pull-Out Type Droplet Generation System

4.1 Configuration

4.2 Operation

4.3 Problems

4.4 Configuration of Nozzle

5. Wettability of Various Materials with Molten Tin
6. Reactivity with Molten Tin

### 7. Other Target Supply Devices

### 1. Summary

In an LPP type EUV light generation system, a target material may be discharged in the form of droplets from a target supply device, and the liquid target material may be irradiated with a pulsed laser beam when the droplet reaches a plasma generation region, whereby the target material is turned into plasma and EUV light is emitted from the plasma.

In the EUV light generation system, if the position of the target material reaching the plasma generation region is unstable, energy and positions of the pulsed EUV light may vary. Pertaining to this issue, it is contemplated that the positional stability of the droplets reaching the plasma generation region may be affected by the wettability of the nozzle surface of the target supply device with the target material.

For example, in the target supply device which includes a nozzle, at least an outer surface region around an orifice of the nozzle may be formed of a material with which the target material in a molten state has a contact angle greater than 90 degrees with respect to a surface of the outer surface region. In this case, even when the target material discharged through the orifice comes into contact with the outer surface region around the orifice, the direction into which the droplets of the target material are discharged may be stabilized, since the outer surface region around the outlet has low wettability with the liquid target material.

### 2. Terms

Terms used in this application will be defined as follows. A “chamber” is a container for isolating a space in which plasma is generated from the outside. A “target supply device” is a device for supplying a target material, such as tin in molten state, used to generate EUV light into the chamber. An “EUV collector mirror” is a mirror for reflecting and outputting EUV light emitted from the plasma. “Debris” may include neutral particles, of the target material supplied into the chamber, that have not been turned into plasma, and ion particles emitted from the plasma, and may cause contamination or damage to an optical element such as the EUV collector mirror.

### 3. Overview of EUV Light Generation System

### 3.1 Configuration

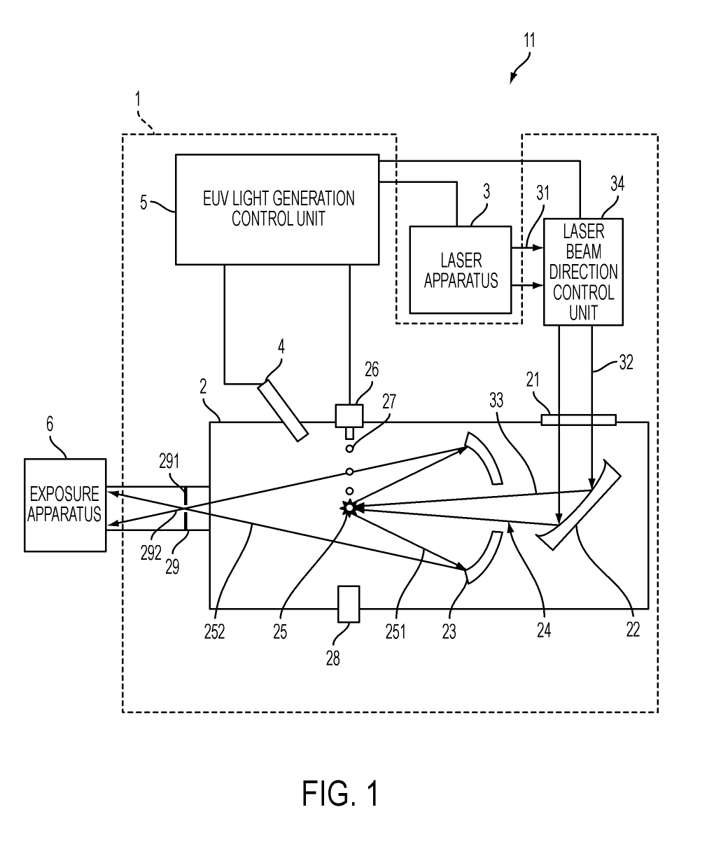

FIG. 1 schematically illustrates the configuration of an exemplary LPP type EUV light generation system. An EUV light generation apparatus 1 may be used with at least one laser apparatus 3. In this application, a system including the EUV light generation apparatus 1 and the laser apparatus 3 may be referred to as an EUV light generation system 11. As illustrated in FIG. 1 and described in detail below, the EUV light generation apparatus 1 may include a chamber 2, a target supply device (droplet generator 26, for example), and so forth. The chamber 2 may be airtightly sealed. The target supply device may be mounted to the chamber 2 so as to penetrate the wall of the chamber 2, for example. A target material to be supplied by the target supply device may include, but not limited to, tin, terbium, gadolinium, lithium, xenon, or any combination thereof.

The chamber 2 may have at least one through-hole formed in its wall. The through-hole may be covered with a window 21, and a pulsed laser beam 32 may pass through the window 21. An EUV collector mirror 23 having a spheroidal reflective surface may be disposed inside the chamber 2, for example. The EUV collector mirror 23 may have a multi-layered reflective film formed on a surface thereof, the reflective film being formed of molybdenum and silicon being laminated alternately, for example. The EUV collector mirror 23 may have first and second foci. The EUV collector mirror 23 may preferably be disposed such that the first focus lies in a plasma generation region 25 and the second focus lies in an intermediate focus (IF) 292 defined by the specification of an exposure apparatus. The EUV collector mirror 23 may have a through-hole 24 formed at the center thereof, and a pulsed laser beam 33 may travel through the through-hole.

The EUV light generation system 11 may include an EUV light generation control unit 5. Further, the EUV light generation system 1 may include a target sensor 4. The target sensor 4 may have an imaging function and may detect at least one of the presence, trajectory, and position of a target.

Further, the EUV light generation apparatus 1 may include a connection 29 for allowing the interior of the chamber 2 and the interior of the exposure apparatus 6 to be in communication with each other. A partition 291 having an aperture may be disposed inside the connection 29. The partition 291 may be disposed such that the second focus of the EUV collector mirror 23 lies in the aperture formed in the partition 291.

Further, the EUV light generation system 11 may include a laser beam direction control unit 34, a laser beam focusing mirror 22, and a target collection unit 28 for collecting targets 27. The laser beam direction control unit 34 may include an optical element for defining the direction into which the laser beam travels and an actuator for adjusting the position and the posture of the optical element.

### 3.2 Operation

With reference to FIG. 1, a pulsed laser beam 31 outputted from the laser apparatus 3 may pass through the laser beam direction control unit 34 and, as a pulsed laser beam 32, may travel through the window 21 and enter the chamber 2. The pulsed laser beam 32 may travel inside the chamber 2, be reflected by the laser beam focusing mirror 22, and, as a pulsed laser beam 33, strike at least one target 27.

The droplet generator 26 may output the targets 27 toward the plasma generation region 25 inside the chamber 2. The target 27 may be irradiated with at least one pulse included in the pulsed laser beam 33. The target 27 that has been irradiated with the pulsed laser beam 33 may be turned into plasma, and rays of light including EUV light 252 may be emitted from the plasma. The EUV light 252 may be reflected selectively by the EUV collector mirror 23. The EUV light 252 reflected by the EUV collector mirror 23 may travel through the intermediate focus 292 and be outputted to the exposure apparatus 6. The target 27 may be irradiated with multiple pulses included in the pulsed laser beam 33.

The EUV light generation control unit 5 may control the entire EUV light generation system 11. The EUV light generation control unit 5 may process image data of the droplets 27 captured by the target sensor 4. Further, the EUV light generation control unit 5 may control at least one of the timing at which the target 27 is outputted and the direction into which the target 27 is outputted, for example. Furthermore, the EUV light generation control unit 5 may control at least one of the timing at which the laser apparatus 3 oscillates, the direction in which the pulsed laser beam 32 travels, and the position at which the pulsed laser beam 33 is focused, for example. The various controls mentioned above are merely examples, and other controls may be added as necessary.

### 4. Electrostatic-Pull-Out Type Droplet Generation System

### 4.1 Configuration

An electrostatic-pull-out type droplet generation system comprising a target supply device (droplet generator 26 shown in FIG. 1, for example) and the EUV light generation control unit 5 will be described.

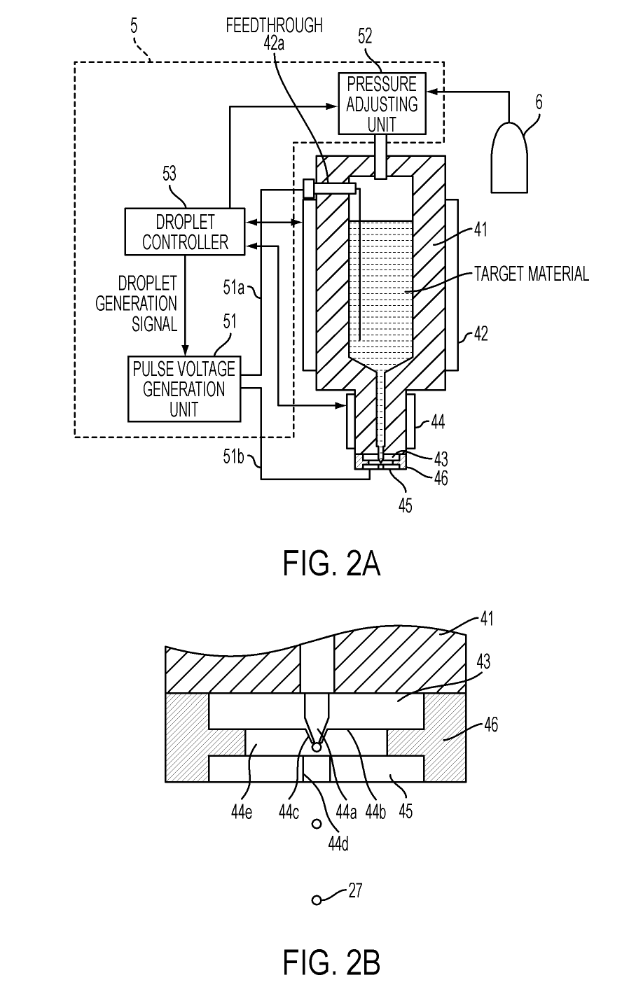

FIG. 2A is a partial sectional view illustrating the configuration of the electrostatic-pull-out type droplet generation system, which includes a target supply device according to any of first through fourth embodiments and in which droplets are generated using the electrostatic force. FIG. 2B is an enlarged sectional view illustrating part of the electrostatic-pull-out type droplet generation system shown in FIG. 2A.

As illustrated in FIG. 2A, the electrostatic-pull-out type droplet generation system may include a reservoir 41, a heater 42, a nozzle 43, a heater 44, a pull-out electrode 45, an insulating material 46, the EUV light generation control unit 5, and an inert gas cylinder 6. The reservoir 41 and the nozzle 43 may be formed integrally or separately. Here, at least the reservoir 41 and the nozzle 43 may constitute the target supply device. The target supply device may further include at least one of the heater 42, the heater 44, the pull-out electrode 45, and the insulating material 46.

Electrically conductive metal or the like may be used as the target material. In the embodiments of this disclosure, tin (Sn) is an example of the target material. The melting point of tin is 232° C. The reservoir 41 may correspond to a target storage unit for storing tin (target material) and supplying tin in molten state into the nozzle 43. The heaters 42 and 44 may be mounted around the reservoir 41 and heat the reservoir 41 so that tin serving as the target material inside the reservoir 41 is kept in a molten state. Here, either of the heaters 42 and 44 may include a temperature sensor (not shown) for detecting the temperature of the reservoir 41.

The nozzle 43 may correspond to a target discharge unit for discharging the target material toward a predetermined region inside the chamber 2 (See FIG. 1). As illustrated in FIG. 2B, a through-hole (orifice) 44a may be formed in the nozzle 43, and the target material may be discharged through the through-hole 44a. Further, as illustrated in FIG. 2B, the nozzle 43 may have a tip portion 44c projecting from an outer surface 44b, and the electric field may be enhanced at the target material in the tip portion 44c.

The pull-out electrode 45 may be disposed so as to face the outer surface 44b of the nozzle 43. The electric field may be generated between the nozzle 43 and the pull-out electrode 45 so that the target material is pulled out through the orifice 44a in the nozzle 43. Here, the pull-out electrode 45 may have a through-hole 44d formed at the center, through which the target material may travel toward the plasma generation region 25. The insulating material 46 may be disposed between the nozzle 43 and the pull-out electrode 45 so as to provide electrical insulation therebetween. The insulating material 46 may have a through-hole 44e formed at the center, through which the target material may travel toward the plasma generation region 25.

Referring again to FIG. 2A, the EUV light generation control unit 5 may include a pulse voltage generation unit 51, a pressure adjusting unit 52, and a droplet controller 53. Wiring 51a connected to one output terminal of the pulse voltage generation unit 51 may be in contact with the target material via an airtight terminal (feedthrough) 42a provided to the reservoir 41. Wiring 51b connected to the other output terminal of the pulse voltage generation unit 51 may be connected to the pull-out electrode 45. With this, the pulse voltage generation unit 51 may apply pulse voltage between the target material and the pull-out electrode 45. When the nozzle 43 is made of metal, the pulse voltage generation unit 51 may apply pulse voltage between the nozzle 43 and the pull-out electrode 45.

The pressure adjusting unit 52 may be configured to pressurize the target material inside the reservoir 41 using the inert gas supplied from the inert gas cylinder 6 and push out the target material to the tip of the nozzle 43. The droplet controller 53 may control the pulse voltage generation unit 51 and the pressure adjusting unit 52 so that the droplets 27 are generated at given timing.

### 4.2 Operation

The electrostatic-pull-out type droplet generation may generate droplets on-demand. The droplet controller 53 may control the heaters 42 and 44 so that the reservoir 41 is at a predetermined temperature at or above 232° C. at which tin (Sn) melts. With this, tin inside the reservoir 41 may be retained in a molten state.

The droplet controller 53 may output droplet generation signals to the pulse voltage generation unit 51. The pulse voltage generation unit 51 may respond to the droplet generation signals and apply pulsed high voltage between the target material and the pull-out electrode 45. With this, the target material may be pulled out from the tip portion 44c projecting from the outer surface 44b of the nozzle 43 by the Coulomb force and be separated from the tip, whereby a droplet is generated. Here, if necessary, under the control of the droplet controller 53, the pressure adjusting unit 52 may pressurize the target material using a gas that does not react with the target material so that the target material protrudes from the tip portion 44c of the nozzle 43.

### 4.3 Problems

In such electrostatic-pull-out type droplet generation system, the tip portion 44c of the nozzle may project in a tapered shape so that the electric field is enhanced at the target material. Further, the orifice 44a at the tip of the nozzle may preferably be a few pm in diameter in order to generate a droplet that is 10 to 30 μm in diameter.

When the outer surface 44b around the orifice 44a becomes wet with the target material, an electric field may not be enhanced for the target material. As a result, production efficiency of the droplets may be reduced. Further, even when the droplets are generated, the direction into which the droplets are outputted may become unstable; thus, the positional stability of the droplets may be deteriorated. That is, when the outer surface 44b around the orifice is highly wettable with the target material, droplets may not be generated desirably.

Accordingly, in the embodiments of this disclosure, at least the outer surface 44b around the orifice may be formed of a material that has low wettability with the target material. Further, this material preferably has low reactivity with the target material. In this disclosure, a material is said to have low wettability with the liquid target material when the target material has a contact angle greater than 90 degrees with a surface made of that material. Further, a material is said to have high wettability with the liquid target material when the target material has a contact angle at or smaller than 90 degrees with a surface made of that material.

### 4.4 Configuration of Nozzle

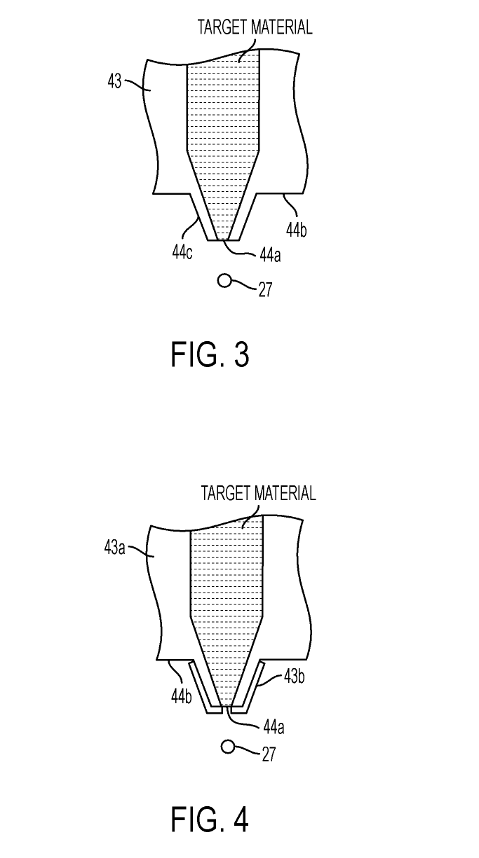

FIG. 3 is a sectional view illustrating part of a nozzle of a target supply device according to a first embodiment. In the first embodiment, the nozzle 43 is made of a material having low wettability with the target material.

FIG. 4 is a sectional view illustrating part of a nozzle of a target supply device according to a second embodiment. When a material having high wettability with the target material is used for the nozzle, at least the outer surface 44b around the orifice may be coated with a material having low wettability with the target material. Accordingly, the nozzle may include a nozzle body 43a and a coating 43b. Alternatively, the nozzle body 43a may be coated, on the entire surface thereof, with a material having low wettability with the target material.

The nozzle may be formed of an electrically insulating material or a semiconductor material. When the nozzle is formed of an electrically insulating material or a semiconductor material, the electric field may be enhance at the target material even when the tip portion 44c projecting from the outer surface 44b of the nozzle is not provided as shown in FIG. 2B. Even if this is the case, at least the outer surface 44b around the orifice 44a may include a material having low wettability with the target material.

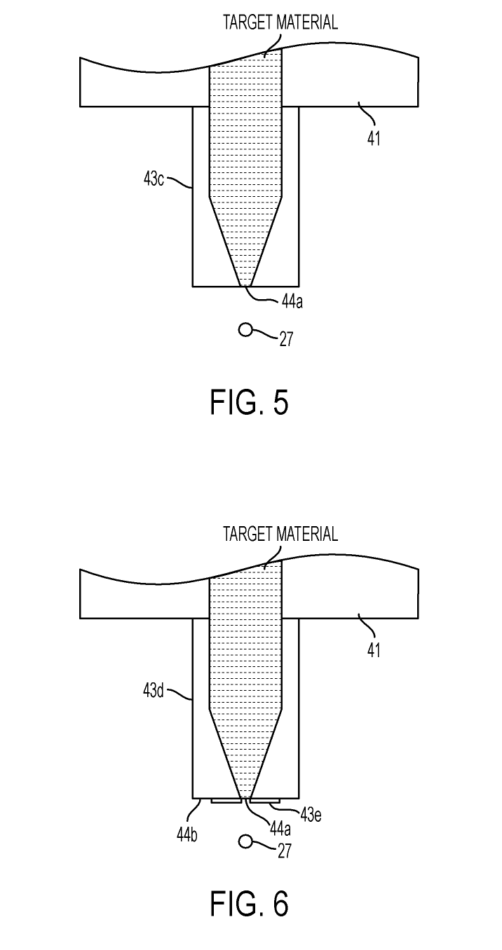

FIG. 5 is a sectional view illustrating part of a nozzle of a target supply device according to a third embodiment. In the third embodiment, a nozzle 43c may be formed of an insulating material or a semiconductor material having low wettability with the target material. Accordingly, the nozzle 43c may also function as the insulating material 46 shown in FIG. 2A.

FIG. 6 is a sectional view illustrating part of a nozzle of a target supply device according to a fourth embodiment. In the fourth embodiment, a nozzle may be formed of an insulating material or a semiconductor material having high wettability with the target material. Here, at least the outer surface 44b around the orifice 44a may be coated with a material having low wettability with the target material. Accordingly, the nozzle may include a nozzle body 43d and a coating 43e. Alternatively, the nozzle body 43d may be coated, on the entire surface thereof, with a material having low wettability with the target material. The material to be coated with may preferably be an insulating material or a semiconductor material. In the fourth embodiment, the nozzle body 43d or the coating 43e may function as the insulating material 46 shown in FIG. 2A.

In this way, configuring at least the outer surface region around the orifice with a material having low wettability with the target material and preferably having low reactivity with the target material may make it possible to improve the generation efficiency of the droplets and the positional stability of the droplets.

5. Wettability of Various Materials with Molten Tin

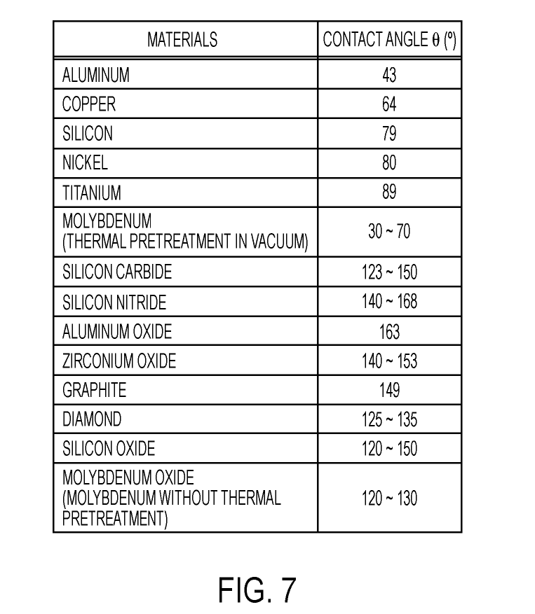

FIG. 7 is a table showing contact angles of various materials with molten tin. This data is taken from “Wettability Technology Handbook˜Fundamentals•Measurement Evaluation•Data˜” (Isii, Tosio; Koishi, Masumi; and Tsunoda, Teruo (Eds.), Techno System). In general, a state where a contact angle θ is in a range of 0°<θ≦90° is referred to as immersional wetting, and a liquid eventually will soak into a solid material. On the other hand, a state where a contact angle e is in a range of 180°≧θ90° is referred to as adhesive wetting, and the wetting is less likely to proceed.

As shown in FIG. 7, silicon carbide, silicon nitride, aluminum oxide, zirconium oxide, graphite, diamond, silicon oxide, molybdenum oxide (oxide layer of molybdenum that is not subjected to thermal pretreatment), and so forth have a contact angle e within a range of 180°≧θ90°, and have low wettability with molten tin. Tungsten oxide and tantalum oxide may also have a contact angle e within a range of 180°≧θ>90°, and be considered to have low wettability with molten tin.

Meanwhile, metal materials or semiconductor single materials, such as aluminum, copper, silicon, nickel, titanium, molybdenum (thermal pretreatment in vacuum) have a contact angle θ within a range of 0°<θ≦90°, and have high wettability with molten tin. Tungsten and tantalum are considered to become more wettable when being subjected to thermal pretreatment in vacuum.

6. Reactivity with Molten Tin

Reactivity of various materials with molten tin will be discussed below. Tungsten, tantalum, and molybdenum, which are high-melting-point materials, are less reactive with molten tin. Further, silicon carbide, silicon nitride, aluminum oxide, zirconium oxide, graphite, diamond, silicon oxide, and molybdenum oxide are also less reactive with molten tin. Similarly, tungsten oxide and tantalum oxide are considered to be less reactive with molten tin.

Accordingly, silicon carbide, silicon nitride, aluminum oxide, zirconium oxide, graphite, diamond, silicon oxide, molybdenum oxide, tungsten oxide, or tantalum oxide may be used as a material for the nozzle. Alternatively, at least the outer surface 44b around the orifice 44a may be coated with any of the above materials (see, e.g., FIG. 4), or the entire outer surface of the nozzle may be coated with any of the above materials.

As one example, molybdenum may be used as a material for a nozzle in the embodiments of this disclosure. That nozzle may react with oxygen and thus be oxidized at high temperature, whereby a layer of an oxide (molybdenum oxide) may be formed on a surface of the nozzle. With this, the surface of the nozzle may be coated with the oxide. Preferably, the only outer surface of the nozzle except for the inner surface of the orifice may be coated with the oxide, and molybdenum may be exposed on part of the inner surface of the orifice which comes into direct contact with molten tin. A contact angle of molybdenum surface that has been subjected to thermal treatment in vacuum with molten tin is 30° to 70°; thus, the molybdenum surface is highly wettable with molten tin. That is, the inner surface of the orifice may be highly wettable with molten tin; thus, molten tin may reach the tip of the nozzle more easily. Alternatively, the nozzle may be configured of tungsten or tantalum, which is both a high-melting-point material, and at least outer surface region around the orifice may be oxidatively-treated.

As another example, the nozzle may be formed of a non-metal material that hardly reacts with molten tin, such as silicon carbide, silicon nitride, silicon oxide (silica glass or the like), aluminum oxide (sapphire), graphite, diamond, and so forth. In particular, in the electrostatic-pull-out type droplet generation system, silica glass or silicon carbide, which is a material having a low dielectric constant, may be preferable.

As yet another example, diamond may preferably be used as a material for the nozzle since its sputtering rate by ions generated when the target material is turned into plasma is low. When the nozzle is formed by diamond, part of the inner surface of the orifice which comes into direct contact with molten tin may be coated with a material that is highly wettable with molten tin and that hardly reacts with molten tin (molybdenum, tantalum, or tungsten, for example). Here, the coating material may contain oxygen, and if that is the case, an oxide layer may be formed upon the inner surface of the orifice being coated with such material. In that case, the oxide layer formed thereon may preferably be removed.

### 7. Other Target Supply Devices

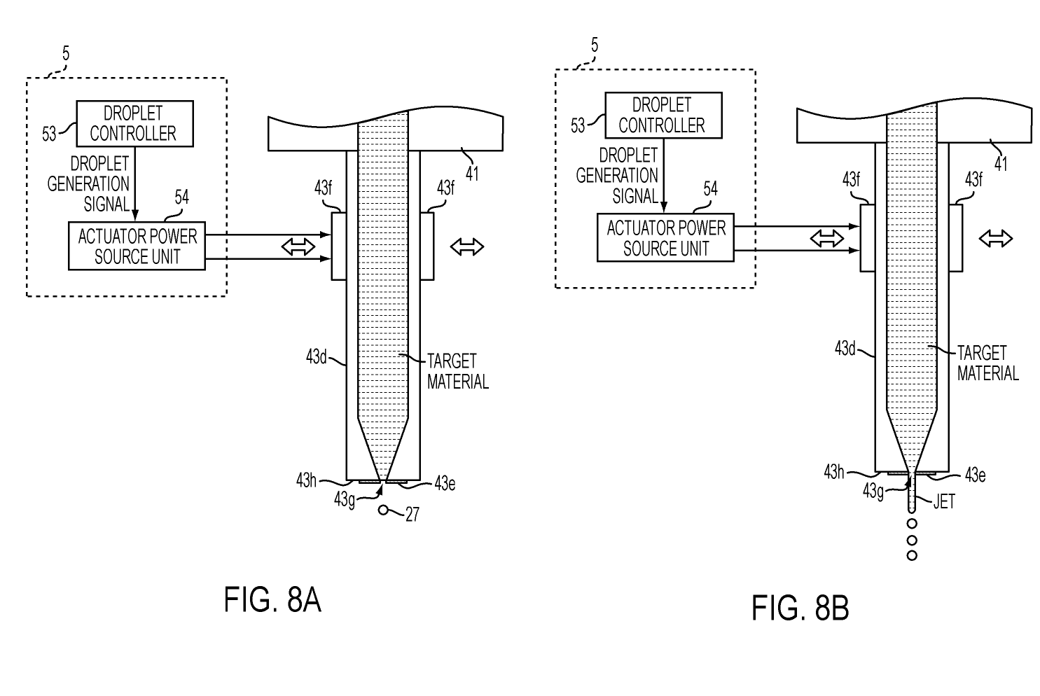

FIGS. 8A and 8B are partial sectional views illustrating the configuration of a droplet generation system which includes a target supply device according to a fifth embodiment. In the fifth embodiment, a piezoelectric element, such as PZT (lead zirconate titanate), and an actuator including electrodes formed at both ends of the piezoelectric element may be disposed on the nozzle body of the target supply device.

A material for the nozzle may be any of a metal material, a semiconductor material, and an insulating material; however, FIGS. 8A and 8B illustrate an example in which the nozzle is formed of an insulating material or a semiconductor material. An orifice 43g may be formed at the leading end of the nozzle. It is preferable that a material having high wettability with the target material is used as a material for the nozzle, and that at least the outer surface 43h around the orifice 43g may be coated with a material having low wettability with the target material. Here, the material with which the outer surface 43h is to be coated may preferably be an insulating material or a semiconductor material as well. As shown in FIGS. 8A and 8B, the nozzle according to the fifth embodiment may include the nozzle body 43d, the coating 43e, and an actuator 43f.

Further, the EUV light generation control unit 5 may include the droplet controller 53 and an actuator power source unit 54. The droplet controller 53 may output droplet generation signals to the actuator power source unit 54. The actuator power source unit 54 may respond to the droplet generation signals, and apply a pulsed voltage between the electrodes of the actuator 43f. With this, the piezoelectric element of the actuator 43f may deform.

As illustrated in FIG. 8A, voltage may be applied between the electrodes of the actuator 43f, and the nozzle body 43d may be pressurized from outside. With this, the pressure on the target material inside the nozzle body 43d may rise temporarily, whereby the target material may be discharged through the nozzle and the droplet 27 may be generated. Accordingly, in the fifth embodiment, the pull-out electrode 45, the insulating material 46, and the pulse voltage generation unit 51 shown in FIG. 2A may not be necessary. It is noted that this disclosure is not limited to an actuator in which a piezoelectric element is used. A mechanism for pressurizing the target material inside the nozzle at high speed may be provided, whereby the droplet 27 may be generated on-demand.

In addition, as shown in FIG. 8B, the target material can be pressurized with an inert gas that hardly reacts with the target material so that a jet of the target material is discharged through the nozzle. The configuration for pressurizing the target material may be similar to that shown in FIG. 2A. Further, in FIG. 8B, vibration is added to the nozzle using the actuator 43f. In this way, the droplets may be generated with a so-called continuous jet method. The continuous jet method can generate substantially uniform size droplets by controlling the frequency of the voltage to be applied to the actuator 43f.

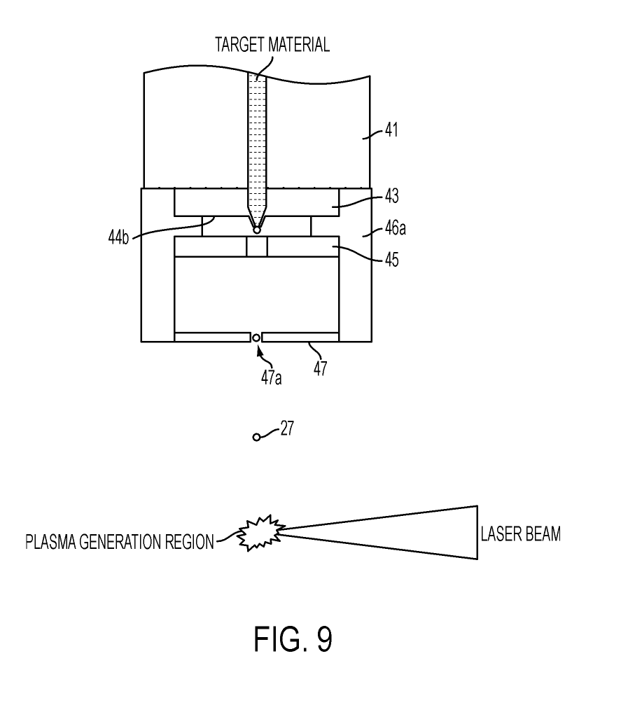

FIG. 9 is a sectional view illustrating part of a target supply device according to a sixth embodiment. In an LPP type EUV light generation apparatus, debris generated in the plasma generation region (corresponding to the plasma generation region 25 shown in FIG. 1) is likely to reach the nozzle. Accordingly, in the sixth embodiment, a debris protection plate 47 may be disposed to reduce the amount of debris reaching the nozzle 43. As illustrated in FIG. 9, the debris protection plate 47 may be disposed between the nozzle 43 and the plasma generation region. The debris protection plate 47 may be supported by an insulating material 46a which also supports the pull-out electrode 45. The debris protection plate 43 has a through-hole 47a through which the droplets may travel toward the plasma generation region. The debris protection plate 47 may preferably be formed of a material having anti-sputtering properties. Since the outer surface 44b around the orifice include a material to allow the target material to have a contact angle greater than 90 degrees with respect to the outer surface 44b, the positional stability of the droplets may be improved. As a result, the through-hole in the debris protection plate 47 can be small, and the debris reaching the nozzle can thus be reduced.

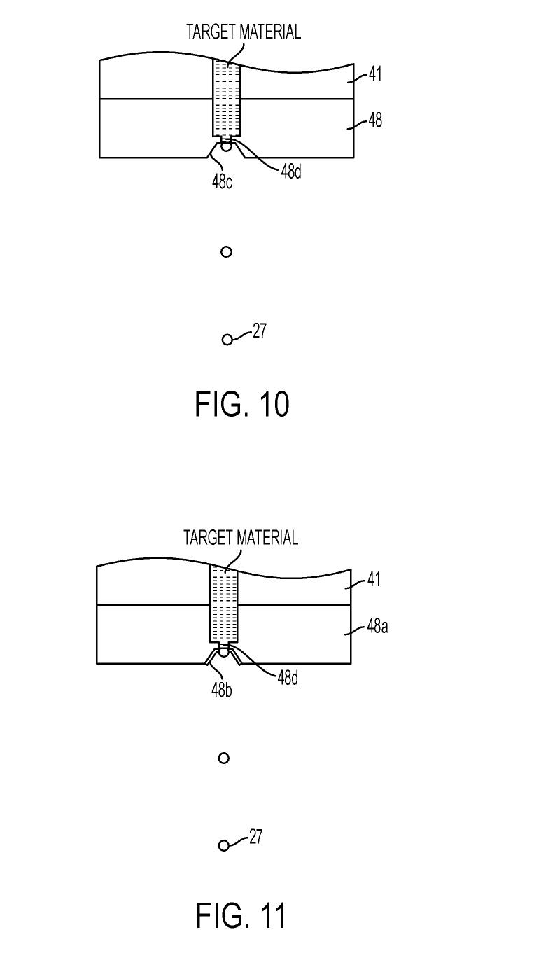

FIG. 10 is a sectional view illustrating part of a target supply device according to a seventh embodiment. In the seventh embodiment, a plate 48 may be used, in place of the nozzle, as the target discharge unit for discharging the target material toward a region inside the chamber 2 (See FIG. 1). An insulating material or a semiconductor material which has low wettability with the target material may be used as a material for the plate 48. As illustrated in FIG. 10, a recess 48c may be formed in the output surface side of the plate 48, and a through-hole (orifice) 48d may be formed at the center of the recess 48c, through which the target material may be discharged. When the plate 48 is configured in this way, where the plate 48 is thinner at the orifice portion in the direction in which the target material flows, the area at which the orifice portion comes into contact with the target material may become smaller. When the area at which the orifice portion comes into contact with the target material becomes smaller, the disturbance of the target material thus becomes smaller, whereby the direction into which the droplets are discharged may be stabilized.

FIG. 11 is a sectional view illustrating part of a target supply device according to an eighth embodiment. An insulating material or a semiconductor material which has high wettability with the liquid target material may be used as a material for a plate. In this case, at least the outer surface region around the orifice 48d may be coated with a material having low wettability with the target material. Accordingly, the plate may include a plate body 48a and a coating 48b. Alternatively, the plate body 48a made of the insulating or semiconductor material may be coated, on the entire surface thereof, with a material having low wettability with the target material. Here, the material with which the plate body 48a is to be coated may preferably be an insulating or semiconductor material as well.

The above-described embodiments and the modifications thereof are merely examples for implementing this disclosure, and this disclosure is not limited thereto. Making various modifications according to the specifications or the like is within the scope of this disclosure, and it is apparent from the above description that other various embodiments are possible within the scope of this disclosure. For example, the modifications illustrated for particular ones of the embodiments can be applied to other embodiments as well (including the other embodiments described herein).

The terms used in this specification and the appended claims should be interpreted as “non-limiting.” For example, the terms “include” and “be included” should be interpreted as “including the stated elements but not being limited to the stated elements.” The term “have” should be interpreted as “including the stated elements but not being limited to the stated elements.” Further, the modifier “one (a/an)” should be interpreted as at least one or “one or more.”

What is claimed is:

1. A target supply device for supplying a target material for generating an extreme ultraviolet (EUV) light, comprising:
a target storage unit for storing at least the target material; and
a target discharge unit comprising a surface having an opening from which a through-hole extends to communicate with the target storage unit, the target material being discharged through the opening for generating the EUV light, the surface at least around the opening being formed of a material so that the target material has a contact angle greater than 90 degrees with the surface.

2. The target supply device according to claim 1, wherein the surface at least around the opening is coated with the material so that the target material has a contact angle greater than 90 degrees with the surface.

3. The target supply device according to claim 1, wherein
the target material is tin, and
the material includes any one of silicon carbide, silicon oxide, aluminum oxide, silicon nitride, zirconium oxide, molybdenum oxide, graphite, diamond, tungsten oxide, and tantalum oxide.

4. The target supply device according to claim 2, wherein
the target material is tin, and
the material includes any one of silicon carbide, silicon oxide, aluminum oxide, silicon nitride, zirconium oxide, molybdenum oxide, graphite, diamond, tungsten oxide, and tantalum oxide.

5. The target supply device according to claim 1, wherein an inner surface of the through-hole of the target discharge unit coming into contact with the target material satisfies 0°<θ≦90°, where θ is the contact angle with the inner surface.

6. The target supply device according to claim 2, wherein an inner surface of the through-hole of the target discharge unit coming into contact with the target material satisfies 0°<θ≦90°, where θ is the contact angle with the inner surface.

7. The target supply device according to claim 5, wherein
the target material is tin, and
the inner surface of the through-hole is formed of a material containing any one of molybdenum, tungsten, and tantalum.

8. The target supply device according to claim 6, wherein
the target material is tin, and
the inner surface of the through-hole is formed of a material containing any one of molybdenum, tungsten, and tantalum.

9. An extreme ultraviolet light generation apparatus, comprising the target supply device according to claim 1.

10. An extreme ultraviolet light generation apparatus, comprising the target supply device according to claim 2.
